(19) United States
(12) Patent Application Publication
(10) Pub. No.: US 2008/0252054 A1
(43) Pub. Date: Oct. 16, 2008

(54) AIR BAG CUSHION

(75) Inventors: Chang Soo KIM, Gyeonggi-do (KR); Jong Hyub JUN, Gyeonggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Gyeonggi-do (KR)

(21) Appl. No.: 12/029,121

(22) Filed: Feb. 11, 2008

(30) Foreign Application Priority Data
Apr. 16, 2007 (KR) 10-2007-0036936
Aug. 23, 2007 (KR) 10-2007-0084962

(51) Int. Cl. B60R 21/16

(52) U.S. Cl. 280/743.2; 280/743.1

(57) ABSTRACT

An air bag cushion includes a lower chamber including at least one bottom panel and defining a lower space by an introduced gas, and an upper chamber including a plurality of top panels and a volume control panel and combined with the lower chamber, the volume control panel being disposed in at least any one of spaces between the top panels and defining an upper space together with the top panels.

This Nonprovisional application claims priority under 35 U.S.C. §119(a) on Patent Application No. 10-2007-0036936 filed in Korea on Apr. 16, 2007 and No. 10-2007-0084962 filed in Korea on Oct. 23, 2007, the entire contents of which are hereby incorporated by reference.

### BACKGROUND OF THE INVENTION

1. Field of the Invention

The present invention relates to an air bag cushion, and more particularly, to a side air bag cushion for more safely protecting a passenger from a physical impact occurring upon vehicle collision.

2. Description of the Background Art

Air bag systems are devices for absorbing, by elasticity of an air bag cushion, a physical impact occurring upon vehicle collision and protecting a passenger in a vehicle. Air bag systems can be classified into driver air bag systems, assistant driver air bag systems, and side air bag systems.

In general, side air bag systems are installed in seats or car-body fillers. The side air bag systems protect passenger's head and shoulder from colliding with a hard door when a passenger leans to a door side or a door is crushed inside during a side collision event. Also, the side air bag systems protect a passenger from injury by broken pieces of glass and prevent the passenger from being bounced out of a vehicle.

A conventional air bag cushion will be described with reference to FIG. 1 below.

An air bag cushion 10 for a side air bag system can be divided into a lower chamber 40 for protecting passenger's lumbar part and an upper chamber 50 for protecting passenger's chest part. Considering a feature of a human body colliding with an inner side part of a vehicle and a feature of a package disposed at a side part of the vehicle, the air bag cushion 10 should be constructed such that the upper chamber 50 for protecting the chest part has a lower pressure than the lower chamber 40 for protecting the lumbar part. This requires deciding a shape of the air bag cushion 10 such that the upper chamber 50 is larger in volume than the lower chamber 40 when the air bag cushion 10 is inflated with an introduced gas. In view of this, the conventional art shown in FIG. 1 controls a volume such that the upper chamber 50 is larger than the lower chamber 40 in volume, using a position of a partition tether 30 partitioning the upper chamber 50 and the lower chamber 40. However, such a structure has a drawback that work efficiency reduces because of a difficulty in controlling an optimal inner pressure and a difficulty in folding and arranging the air bag cushion in a vehicle.

As shown in FIG. 1, if the upper chamber 50 is formed connecting two chambers, there is no choice but to provide a vent hole 20, which allows a discharge of a gas introduced into the air bag cushion for volume inflation, on a connection line 22. However, there is no choice but to provide the vent hole 20 at a side part of the upper chamber 50 because there is a difficulty in providing the vent hole 20 on the connection line 22. However, when the vent hole 20 is provided at a place except the connection line 22, the following drawbacks occur. First, when the vent hole 20 is provided on a panel directing to a side part of a vehicle, there is a drawback that when the air bag cushion 10 is inflated, the vent hole 20 is blocked since the side part of the vehicle is crushed. Alternatively, when the vent hole 20 is provided at an opposite side part of the vehicle, there is a drawback that a gas is jetted directly to a passenger via the vent hole 20, causing a concern about a passenger's burn.

In a case where the air bag cushion 10 is manufactured such that a volume of the upper chamber 50 is larger than that of the lower chamber so as to properly control an internal pressure in the air bag cushion, the following drawback occur. That is, because the upper chamber 50 has a larger volume than the lower chamber 40, when the upper chamber 50 is inflated without limit, the air bag cushion 10 strongly impacts a passenger's chest part with a strong inflation power, bouncing a passenger out. As a solution to this, the upper chamber 50 needs to avoid a sudden inflation, but the solution has not yet been provided until now.

### SUMMARY OF THE INVENTION

Accordingly, the present invention is to solve at least the problems and disadvantages of the background art.

To achieve these and other advantages and in accordance with the purpose of the present invention, as embodied and broadly described, there is provided an air bag cushion. The air bag cushion includes a lower chamber and an upper chamber. The lower chamber includes at least one bottom panel and defines a lower space by an introduced gas. The upper chamber includes a plurality of top panels and a volume control panel and combined with the lower chamber. The volume control panel is disposed in at least any one of spaces between the top panels and defines an upper space together with the top panels.

The top panel may include a first side panel and a second side panel defining the upper space in the upper chamber at sides, and the volume control panel may be disposed between the first side panel and the second side panel. In more detail, the volume control panel connects to the first side panel and the second side panel, respectively, and defines the upper space.

A volume of the top panel may be larger than that of the bottom panel when the air bag cushion is deployed and the volume control panel is inflated to the maximum.

The air bag cushion further includes a partition tether disposed within the air bag cushion and partitioning the upper chamber and the lower chamber. The partition tether partitions horizontally the upper chamber and the lower chamber. The partition tether has a hole configured such that a gas introduced into the upper chamber and the lower chamber can pass between the upper chamber and the lower chamber.

The air bag cushion may further include a dispenser for dispensing a gas introduced into the air bag cushion into the upper chamber and the lower chamber, respectively.

The volume control panel may have a vent hole for discharging a gas introduced into the air bag cushion to control a pressure in the air bag cushion.

The upper chamber further comprises a volume control tether that is combined to the top panels interposing the volume control panel, such that the volume control panel's pressure which is made by gas inflated to the upper chamber is limited to a predetermined pressure. In more detail, the volume control tether may be disposed to support the first side panel and the second side panel. When the volume control panel is inflated to the maximum, a length of the volume control tether may be shorter than a distance spaced between the first side panel and the second side panel connecting with the volume control tether.

### BRIEF DESCRIPTION OF THE DRAWINGS

The invention will be described in detail with reference to the following drawings in which like numerals refer to like elements.

FIG. 1 is a perspective view showing a conventional air bag cushion;

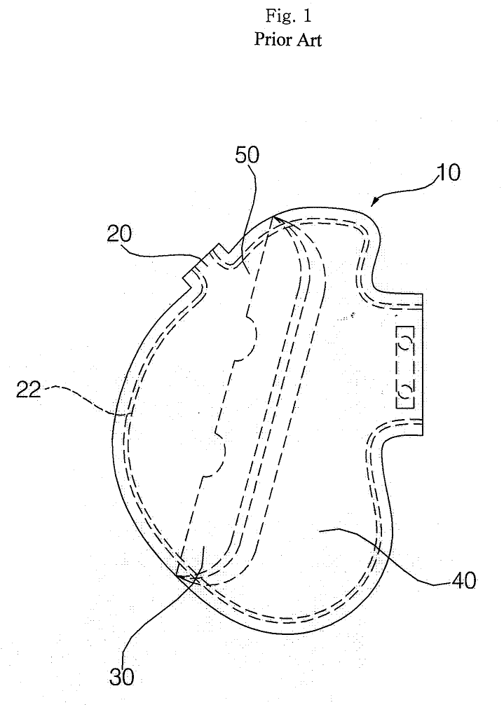

FIG. 2 is a perspective view showing an air bag cushion according to a first exemplary embodiment of the present invention;

FIG. 3 is a front view showing an air bag cushion according to a first exemplary embodiment of the present invention;

FIG. 4 is a front view showing an air bag cushion according to a second exemplary embodiment of the present invention; and

FIG. 5 is a front view showing a volume control tether getting torn in a case where an air bag cushion according to a second exemplary embodiment of the present invention is inflated to the maximum.

### DETAILED DESCRIPTION OF PREFERRED EMBODIMENTS

Preferred embodiments of the present invention will be described in a more detailed manner with reference to the drawings.

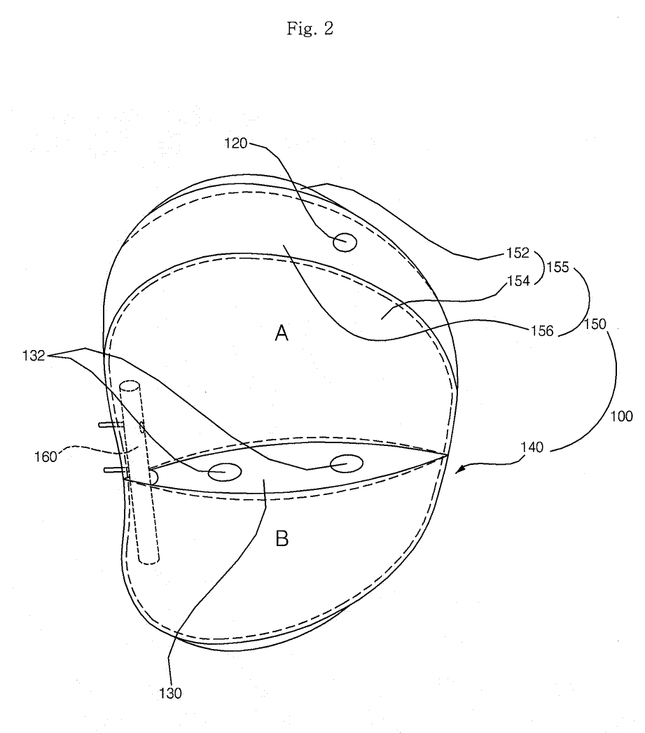

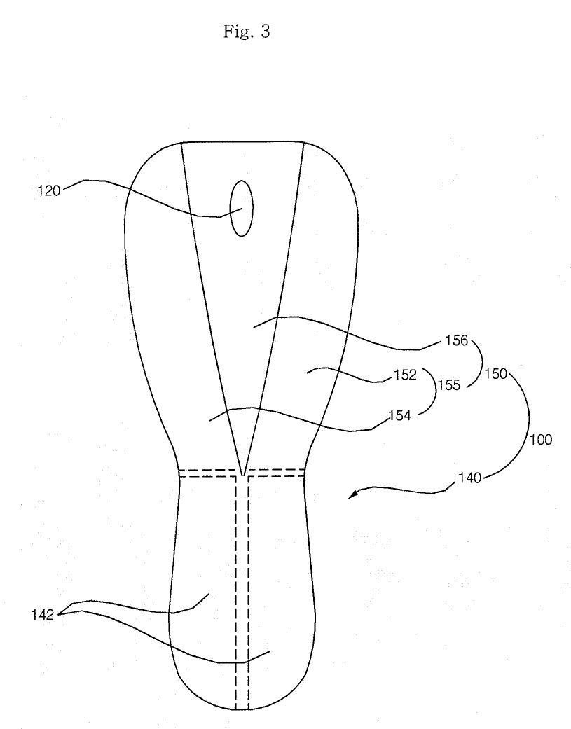

An air bag cushion 100 according to a first exemplary embodiment of the present invention will be described with reference to FIGS. 2 and 3 below.

The air bag cushion 100 includes an upper chamber 150 and a lower chamber 140, which are divided by a partition tether 130.

The lower chamber 140 can be configured in such a manner that two bottom panels 142 are sewn and connected with each other. The lower chamber 140 is not limited to a structure in which exactly two bottom panels 142 are connected with each other. It is enough that one or more bottom panels define a lower space (B).

The upper chamber 150 includes a plurality of top panels 155 partitioning an inner upper space (A), and a volume control panel 156 to be described later. The top panel 155 does not have to be configured with only two panels: a first side panel 152 and a second side panel 154 as shown in FIG. 2, but can be configured with more panels. Further, it is enough for realizing a feature of the present invention that the volume control panel 156 is connected and arranged in at least any one of spaces between the plural top panels. Thus, the volume control panel 156 can be disposed singly or plurally as well if the top panel 155 is constructed with three or more panels.

Construction of the upper chamber 150 will be described in more detail. The upper chamber 150 includes the top panel 155 and the volume control panel 156. The top panel 155 includes the first side panel 152 and the second side panel 154 that define the upper space (A) at both sides. The volume control panel 156 is disposed between the first side panel 152 and the second side panel 154 to connect to each of the first side panel 152 and the second side panel 154. A connection means can use sewing, but has no limitation in that even adherence using an adhesive is available.

The air bag cushion 100 can be provided with a gas inlet and a dispenser 160 that is inserted inside. The gas inlet introduces a high-pressure gas from an inflator (not shown). The dispenser 160 dispenses the introduced high-pressure gas to the upper chamber 150 and the lower chamber 140, respectively.

The gas discharged from the dispenser 160 is dispensed to the upper chamber 150 and the lower chamber 140, respectively. The gas is exchanged in the upper chamber 150 and the lower chamber 140 through a through-hole 132 provided in the partition tether 130.

Operation of the air bag cushion 100 and function of the volume control panel 156 during the operation of the air bag cushion 100 will be described below.

When a vehicle collision accident happens, the air bag cushion 100 is deployed in a vehicle equipped with an air bag system. The gas introduced into the air bag cushion 100 to deploy the air bag cushion 100 is a high-pressure gas that is jetted upon explosion of the inflator (not shown) of the air bag system. In a case where the air bag cushion 100 is equipped with the dispenser 160, the gas jetted from the inflator (not shown) is dispensed to the upper chamber 150 and the lower chamber 140 via the dispenser 160. The dispenser 160 is not an essential element.

It is desirable that the air bag cushion 100 has a sufficient volume and keeps a proper pressure in order for the air bag cushion 100 to protect a passenger from vehicle collision. Thus, the air bag cushion 100 has to have a proper volume and keep a predetermined pressure level when being deployed. When the air bag cushion 100 is deployed upon vehicle collision, a deployment speed reaches about 250 km/h or more. The reason why the air bag cushion has to be deployed at a high speed as above is that the air bag cushion has to be deployed more quickly before a passenger collides against an inner structure of a vehicle. However, as the air bag cushion is deployed at a high speed, it happens that when the air bag cushion collides with the passenger, the passenger is injured due to an impact power caused by a high speed. As a solution to such a drawback, a reduction of a pressure of the air bag cushion is needed, but this has a limitation because there is a limitation of a proper volume and pressure of the air bag cushion as above. Specifically, it is very difficult to control an amount and pressure of jetted gas because explosion of the inflator (not shown) generally leads to generation of gas introduced into the air bag cushion. Thus, there is a need to control a volume of the air bag cushion, optimizing a pressure distribution of the air bag cushion. However, as a result of vehicle collision test and consideration from human body engineering, it has been reported that a conventional air bag cushion 10 should be configured such that an upper chamber 50 protecting a passenger's chest part has a lower pressure than a lower chamber 40 protecting a lumbar part. Thus, it could be understood from the report that it is desirable to design a shape of the air bag cushion 10 such that the upper chamber 50 has a larger volume than the lower chamber 40.

However, as described above, the conventional air bag cushion 10 intended to control volumes of the upper chamber 50 and the lower chamber 40 with a partition tether 30 only, but the partition tether 30 was configured to be slant with respect to the horizontal line because of a deployment feature of the air bag cushion. This, however, has a negative influence upon deployment performance of the air bag cushion because of friction of a folded part of the partition tether 30. Thus, it was difficult to keep a proper internal pressure difference between the upper chamber and the lower chamber upon deployment of the air bag cushion. Also, the presence of the partition tether 30 led to a poor efficiency in folding and installing the air bag cushion in a vehicle.

However, such drawbacks can be overcome owing to the presence of the volume control panel 156 in the inventive air bag cushion. This will be described in detail below.

If gas is introduced into the air bag cushion, the gas is dispensed to the lower chamber 140 and the upper chamber 150, using the dispenser 160. The gas in the lower chamber 140 inflates the lower chamber 140, defining the lower space (B). The gas in the upper chamber 150 inflates the first side panel 152 and the second side panel 154, concurrently inflating the volume control panel 156. However, in this procedure, the upper chamber 150 is deployed relatively larger in volume than the lower chamber 140 owing to the presence of the volume control panel 156. A pressure in the upper chamber 150 can be lower than that of the lower chamber 140, thereby making an originally intended proper pressure distribution in the air bag cushion possible. In addition, the volume control panel 156 increases a volume of the upper chamber 150 while enhancing an installation workability of the air bag cushion. In other words, the air bag cushion can be folded along parts connecting to each of the first side panel 152 and the second side panel 154 of the volume control panel 156 and installed in a vehicle, thereby facilitating an installation work of the air bag cushion and thus enhancing a work performance. Further, the partition tether can be disposed horizontally, not on a slant, thereby facilitating installation of the air bag cushion. If the air bag cushion is folded and installed in such a manner, its symmetrical shape can lead to avoiding a partial increase of a surface friction upon deployment of the air bag cushion, improving a deployment performance of the air bag cushion.

The inventive air bag cushion can achieve the following positive effects owing to the introduction of the volume control panel 156.

As described above, the gas introduced into the air bag cushion 100 is a high-pressure and high-speed gas. However, because it is difficult to accurately control an amount of gas jetted from the inflator, a pressure in the air bag cushion increases beyond limit when gas is jetted more than needed. This induces explosion of the air bag cushion without standing against a high pressure. In order to avoid this, desirably, the gas introduced into the air bag cushion 100 is discharged outside via the vent hole 120. The vent hole 120 can be provided on the volume control panel 156 since the inventive air bag cushion 100 is equipped with the volume control panel 156.

This achieves the following positive effects. In a conventional air bag cushion 10, the vent hole 120 should be provided in a position except a connection line 22 because there is a difficulty in providing the vent hole 120 on the connection line 22. However, when the vent hole 120 is provided on a side part directing to a passenger, the passenger can be injured in a high-temperature gas. Thus, the vent hole 120 is generally provided on an opposite side part. However, it frequently occurs that upon vehicle collision, a side part of a vehicle is impacted and crushed, blocking the vent hole 120. This leads to an increase of a pressure in the air bag cushion beyond tolerable limit, causing a burst of the air bag cushion and thus a passenger's injury. However, the inventive air bag cushion 100 does not have such a drawback since the vent hole 120 is provided on the volume control panel 156. This is a great improvement in reliability and stability of the air bag cushion.

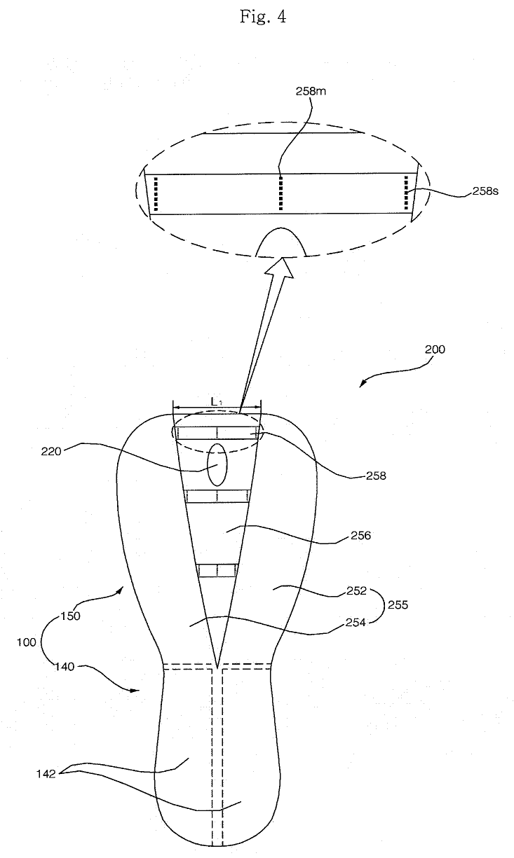

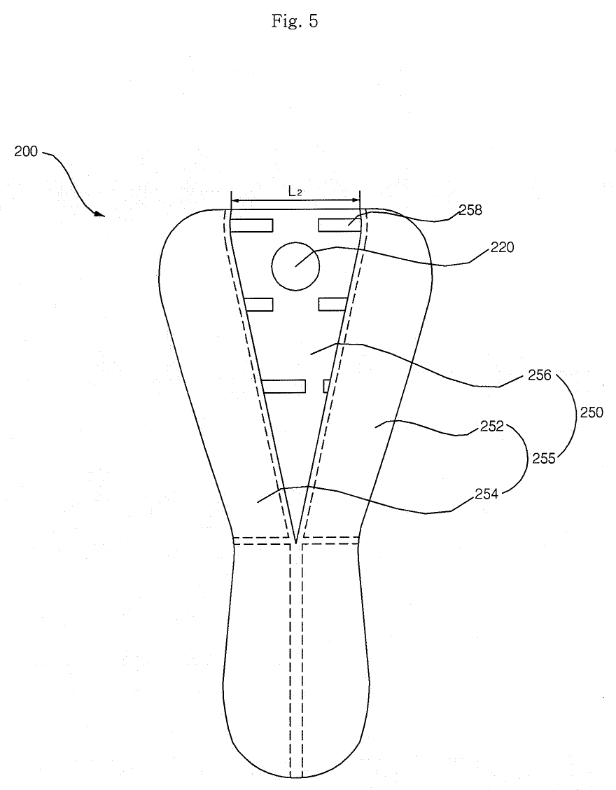

An air bag cushion 200 according to a second exemplary embodiment of the present invention will be described with reference to FIGS. 4 and 5 below.

The air bag cushion 200 according to the second exemplary embodiment of the present invention can be identical with the air bag cushion 100 according to the first exemplary embodiment of the present invention in elements other than a volume control tether and operation. Thus, a repeated description of the first exemplary embodiment of the present invention will be omitted.

The air bag cushion is to prevent a passenger's injury occurring when a passenger collides with other elements in a vehicle. Thus, the air bag cushion requires a deployment speed more than a predetermined level. However, there is a drawback that if the air bag cushion is deployed at a too high peed, an impact power caused by the deployment of the air bag cushion rather injures a passenger. In order to prevent this, an upper chamber 250 of the air bag cushion 200 interposes a volume control panel 256 and includes a volume control tether 258 connecting to a first side panel 252 and a second side panel 254. It is desirable that when the volume control panel 256 is inflated to the maximum, a length (L1) of the volume control tether 258 is smaller than a length (L2) that is a spaced distance between the first side panel 252 and the second side panel 254 connecting with the volume control tether 258.

A function of the volume control tether 258 associated with a procedure of deploying the air bag cushion will be described in detail below.

While the first side panel 252 and the second side panel 254 are deployed using a pressure of an introduced gas, the volume control panel 256 also attempts a restoration to an originally intended shape using an internal pressure. However, the volume control panel's inflating is limited because the volume control tether 258 is combined with the first side panel 252 and the second side panel 254, supporting the first side panel 252 and the second side panel 254. Thus, an upper space (A) is restricted to a constant volume. The restricted volume leads to an increase of a pressure in the upper chamber 250 up to a predetermined level, though the pressure in the upper chamber 250 is restricted within a predetermined range, by a vent hole 220. A pressure of the upper chamber 250 acts as a tensile strength of the volume control tether 258. Thus, the volume control tether 258 controls a sudden inflation of the upper chamber 250 as much as the length (L1) of the volume control tether 258. As a result, the volume control tether 258 prevents a passenger from being impacted upon sudden inflation of the upper chamber 250. If a pressure of the upper chamber 250 keeps increasing, it acts as a tensile strength of the volume control tether 258. The tensile strength gives rise to a stress at each part of the volume control tether 258.

The volume control tether 258 can include a center cut part 258m or side cut parts 258s to concentrate stress on specific parts of the volume control tether 258. In order to induce stress concentration, the cut parts 258m and 258s can be formed in such a manner that a plurality of holes or scratches are provided on the volume control tether 258. Besides a shape giving rise to stress concentration, the cut parts can be of materials having a relative weakness for stress, achieving the same object as well. The concurrent presence of the center cut part 258m and the side cut part 258s is not necessarily required. Only any one of them is enough.

If a pressure of the upper chamber 250 reaches a predetermined level, the center cut part 258m or the side cut part 258s suffers a stress beyond tolerance. As a result, the volume control tether 258 is broken.

If the volume control tether 258 is broken, its tensile strength to limit the inflation of the volume control panel 256 disappears. Hence, the volume control panel 256 is inflated to a shape having an originally intended volume, causing an increase of a volume of the upper chamber 250. Thus, the volume of the upper chamber 250 increases larger than that of the lower chamber 240. As a result, a pressure of the upper chamber 250 can relatively decrease, forming a pressure distribution needed as a side air bag.

The presence of the volume control panel 256 and the volume control tether 258 causes the upper chamber 250 not to be suddenly inflated as much as an originally intended volume by an introduced gas but to be inflated after being once delayed by the volume control tether 258, relieving an inflation power of the upper chamber, thereby preventing a passenger from being injured in the sudden inflation of the air bag cushion.

The volume control tether 258 can be disposed plurally and can be varied in length, thereby stepwise diversifying an inflation degree of the upper chamber 250 and thus attenuating an impact power of the air bag cushion applied to a passenger.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An air bag cushion comprising:
a lower chamber comprising at least one bottom panel and defining a lower space by an introduced gas; and
an upper chamber comprising a plurality of top panels and a volume control panel and combined with the lower chamber, the volume control panel being disposed in at least any one of spaces between the top panels and defining an upper space together with the top panels.

2. The air bag cushion of claim 1, wherein the top panels comprise a first side panel and a second side panel defining the upper space in the upper chamber at sides, and the volume control panel is disposed between the first side panel and the second side panel.

3. The air bag cushion of claim 2, wherein the volume control panel connects to the first side panel and the second side panel, respectively, and defines the upper space.

4. The air bag cushion of claim 1, wherein a volume of the top panel is larger than that of the bottom panel when the volume control panel is inflated to the maximum.

5. The air bag cushion of claim 1, further comprising a partition tether disposed within the air bag cushion and partitioning the upper chamber and the lower chamber.

6. The air bag cushion of claim 5, wherein the partition tether partitions horizontally between the upper chamber and the lower chamber.

7. The air bag cushion of claim 5, wherein the partition tether has a hole configured such that a gas introduced into the upper chamber and the lower chamber can pass between the upper chamber and the lower chamber.

8. The air bag cushion of claim 1, further comprising:
a dispenser that dispenses a gas introduced into the air bag cushion into the upper chamber and the lower chamber, respectively.

9. The air bag cushion of claim 1, wherein the volume control panel has a vent hole that discharges a gas introduced into the air bag cushion to control a pressure in the air bag cushion.

10. The air bag cushion of claim 1, wherein the upper chamber further comprises a volume control tether that is combined to the top panels interposing the volume control panel, such that the volume control panel's pressure which is made by gas inflated to the upper chamber is limited to a predetermined pressure.

11. The air bag cushion of claim 10, wherein the volume control tether supports the first side panel and the second side panel.

12. The air bag cushion of claim 10, wherein when the volume control panel is inflated to the maximum, a length of the volume control tether is shorter than a distance spaced between the first side panel and the second side panel connecting with the volume control tether.
